(19) United States
(12) Patent Application Publication
(10) Pub. No.: US 2026/0368076 A1
(43) Pub. Date: Nov. 19, 2026

(54) SYSTEM AND METHOD FOR ANALYSING FAILED TEST STEPS

(71) Applicant: FIREFLINK PRIVATE LIMITED INDIA, Bangalore (IN)

(72) Inventors: Girish RAMANNA, Bangalore (IN); Ganesh PS, Bengaluru (IN); Jagadeesh H, Bengaluru (IN); Mahesh R, Bengaluru (IN)

(73) Assignee: FIREFLINK PRIVATE LIMITED INDIA, Bangalore (IN)

(21) Appl. No.: 19/126,207

(22) PCT Filed: Oct. 31, 2023
(86) PCT No.: PCT/IB2023/060961

§ 371 Date: Apr. 30, 2025

(30) Foreign Application Priority Data
Oct. 31, 2022 (IN) 202241061770

(51) Int. Cl. G06F 11/3668; G06F 11/3698

(52) U.S. Cl. CPC G06F 11/3692; G06F 11/3688; G06F 11/3698

(57) ABSTRACT

The present invention discloses a system and a method for analyzing a plurality of failed test steps in test suites of a project The system is configured to receive a request for analyzing a plurality of test steps of a test suite, and to execute each of the plurality of test steps of a test suite to determine a plurality of failed test steps of the test suite. The system is further configured to analyze each of the received plurality of failed test steps to create a tag for a failed test step from the plurality of failed test steps in the test suite and to apply the created tag to the failed test step of the test suite, to the plurality of failed test steps of the test suite, or to the plurality of failed test steps of the test suites based on an input from a user.

### FIELD OF INVENTION

The present invention relates to a system and a method for software testing. More specifically, the present invention relates to an automated system and method for analysing failed test steps in test suites of a project through tagging of the failed test steps.

### BACKGROUND OF INVENTION

With the advancement in the technology, various organisations are adopting test automation techniques to manage vast variety of data within the organisation or between multiple organisations. Test automation is a practice of running various software tests automatically, managing test data automatically, and utilizing results to improve software quality. Test automation is primarily a quality assurance measure. Test automation, also known as automated testing or automated QA (quality assurance) testing, is a software testing technique that performs testing of a software using special automated testing software tools to execute a test suite. A test suite is a collection of test cases or test steps grouped together for text execution purposes. Therefore, test automation runs various software tests automatically, thereby eliminating the practise of manual testing performed by a human sitting in front of a computer carefully executing the test steps.

During test automation, a large number of test scripts are executed as a batch or a group of test suites for testing of a software. After execution of the test suites, all the test steps within all the test suites may pass the execution or few of the test steps of few of the test suites may fail, thereby causing redundancy in the test automation. Most of the known system for checking redundancy in test automation require an automation engineer to analyse reasons for the failed test suites of every test step manually. Further, in most of the known systems an error found in a test step is corrected by the automation engineer in that particular test step only. However, there may a case in which same error is present in multiple test steps across multiple test suites. In such a scenario, the automation engineer may have to check all the test steps and all the test suites individually to correct the error, thereby making the entire process prone to errors as few of the test steps may be left by the automation engineer. For example, let's consider a smoke test suite has 100 test steps, out of which 30 test steps got failed. In such a scenario, let's assume that one of the test steps got failed due to an error element “web element like button not found”.

If the same element is used in test steps of same test suite or different test suites at different places gets failed due to same reason, the automation engineer would have to repeat the analysis for the same failure again and again, thereby making the process inefficient and ineffective.

Therefore, there is a need for an automated system and method for analysing failed test steps in test suites of a project. Further, there is a need for an automated system and method for analysis failed test steps through tagging of the failed test steps, thereby reducing iterations in analysis by introducing tagging. Also, there is a need for an automated system and a method in which a tag applied to one failed test step appears in all the failed steps having the same error element, thereby optimizing redundancy in analysing of the failed test steps by reducing number of iterations of analysis of the test steps.

### OBJECT OF INVENTION

The object of the present invention is to provide an automated system and method for analysing failed test steps in test suites of a project. More specifically, the object of the present invention is to provide an automated system and method for analysing failed test steps in a test suite through tagging of the failed test steps. Further, the object of the present invention is to provide an automated system and method in which a tag applied to one failed test step appears in all the failed steps having the same error element, without any human intervention.

### SUMMARY

The present application discloses a system for analyzing a plurality of failed test steps in test suites of a project. The present application discloses that the system includes a client configured to receive a request for analyzing a plurality of test steps of a test suite from a server. The present application discloses that the client includes a processing unit configured to execute each of the plurality of test steps of a test suite to determine a result “Pass” if the test step of the test suite passes the execution without an error element and a result “Fail” if the test step of the test suite fails the execution due to an error element. The processing unit sends the plurality of test steps along with their generated result “Pass or Fail” to the server, wherein the server stores the plurality of test steps along with their generated result “Pass or Fail” in a server database. The server sends the plurality of test steps along with their generated result “Pass or Fail” to the user device for displaying them to the user. Further, the processing unit is configured to extract a plurality of failed test steps from the plurality of test steps based on the generated result “Fail”.

Further, the present application discloses that the client includes a tagging unit configured to receive the extracted plurality of failed test steps from the processing unit, and to analyze each of the received plurality of failed test steps to determine the error element and if error element identity is present in the plurality of failed test steps. The tagging unit is further configured to create a tag for a failed test step from the plurality of failed test steps in the test suite based on the error element and the presence of determined error element identity. Also, the tagging unit is configured to apply the created tag to the failed test step of the test suite, to the plurality of failed test steps of the test suite, or to the plurality of failed test steps of the test suites based on an input from the user. The tagging unit is further configured to store the plurality of failed test steps along with their tags in a client database, and to send the plurality of failed test steps along with their tags to the user device for displaying the failed test steps along with their tags to the user.

The present application further discloses a method for analyzing a plurality of failed test steps in test suites of a project. The method includes receiving, by a processing unit, a request for analyzing a plurality of test steps of a test suite from a server. The method further includes executing, by the processing unit, each of the plurality of test steps of a test suite to determine a result “Pass” if the test step of the test suite passes the execution without an error element and a result “Fail” if the test step of the test suite fails the execution due to an error element. The method includes sending, by the processing unit, the plurality of test steps along with their generated result “Pass or Fail” to the server and storing the plurality of test steps along with their generated result “Pass or Fail” in a server database by the server. Also, the method includes sending, by the server the plurality of test steps along with their generated result “Pass or Fail” to the user device for displaying them to the user.

Further, the method includes extracting, by a processing unit, a plurality of failed test steps from the plurality of test steps based on the generated result “Fail”. Also, the method includes receiving, by a tagging unit, the extracted plurality of failed test steps from the processing unit. The method includes analyzing, by the tagging unit, each of the received plurality of failed test steps to determine the error element and if error element identity is present in the plurality of failed test steps.

Furthermore, the method includes creating, by the tagging unit, a tag for a failed test step from the plurality of failed test steps in the test suite based on the error element and the presence of determined error element identity. Also, the method includes applying, by the tagging unit, the created tag to the failed test step of the test suite, to the plurality of failed test steps of the test suite, or to the plurality of failed test steps of the test suites based on an input from the user. The method includes storing, by the tagging unit, the plurality of failed test steps along with their tags in a client database, and sending, by the tagging unit, the plurality of failed test steps along with their tags to the user device for displaying the failed test steps along with their tags to the user.

### BRIEF DESCRIPTION OF DRAWINGS

The novel features and characteristics of the disclosure are set forth in the description. The disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 illustrates a system 100 for analyzing a plurality of failed test steps in test suites of a project, in accordance with an embodiment of the present disclosure.

FIG. 2A and FIG. 2B illustrate an exemplary tagging of plurality of failed test steps in test suites, in accordance with an embodiment of the present disclosure.

FIG. 3 illustrates an exemplary display screen 300 displayed on the user device 102 requesting an input from the user 110 for applying a tag to a failed test step, in accordance with an embodiment of the present disclosure.

FIG. 4A illustrates an exemplary display screen 400 displayed on the user device 102 with a tag option selected by the user 110, in accordance with an embodiment of the present disclosure.

FIG. 4B illustrates a display screen 402 displayed on the user device 102 after a tag has been applied to a failed test step based on an input from the user 110, in accordance with an embodiment of the present disclosure.

FIG. 5A illustrates an exemplary display screen 500 displayed on the user device 102 with a tag option selected by the user 110, in accordance with another embodiment of the present disclosure.

FIG. 5B illustrates an exemplary display screen 502 displayed on the user device 102 after a tag has been applied to all the failed test steps of a test suite based on an input from the user 110, in accordance with another embodiment of the present disclosure.

FIG. 6 illustrates an exemplary display screen 600 displayed on the user device 102 with a tag option selected by the user 110, in accordance with yet another embodiment of the present disclosure.

FIG. 7 illustrates a method 700 for analyzing a plurality of failed test steps in test suites of a project, in accordance with an embodiment of the present disclosure.

The figures depict embodiments of the disclosure for purposes of illustration only. One skilled in the art will readily recognize from the following description that alternative embodiments of the assemblies, structures and methods illustrated herein may be employed without departing from the principles of the disclosure described herein.

### DETAILED DESCRIPTION

The best and other modes for carrying out the present invention are presented in terms of the embodiments, herein depicted in drawings provided. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect.

The terms “a” and “an” herein do not denote a limitation of quantity, but rather denote the presence of at least one of the referenced items.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

The system, methods, and examples provided herein are only illustrative and not intended to be limiting.

Embodiments of the present invention will be described below in detail with reference to the accompanying figures.

The present invention focusses on providing an automated system and method for analysing failed test steps in test suites through tagging of the failed test steps. With the advancement in the technology, various organisations are adopting test automation techniques to manage vast variety of data within the organisation or between multiple organisations. Test automation is a practice of running various software tests automatically, managing test data automatically, and utilizing results to improve software quality.

During test automation, a large number of test scripts are executed as a batch or a group of test suites for testing of a software. After execution of the test suites, all the test steps within all the test suites may pass the execution or few of the test steps of few of the test suites may fail, thereby causing redundancy in the test automation. Most of the known system for checking redundancy in test automation require an automation engineer to analyse reasons for the failed test suites of every test step manually. Further, in most of the known systems an error found in a test step is corrected by the automation engineer in that particular test step only. However, there may a case in which same error is present in multiple test steps across multiple test suites. In such a scenario, the automation engineer may have to check all the test steps and all the test suites individually to correct the error, thereby making the entire process prone to errors as few of the test steps may be left by the automation engineer.

Therefore, the present invention provides an automated system and method for analysis failed test steps through tagging of the failed test steps, thereby reducing iterations in analysis of test steps by introducing tagging. Further, the present invention provides an automated system and a method in which a tag applied to one failed test step having an error appears in all the failed steps having the same error, thereby optimizing redundancy in analysing of the failed test steps by reducing number of iterations of analysis of the test steps.

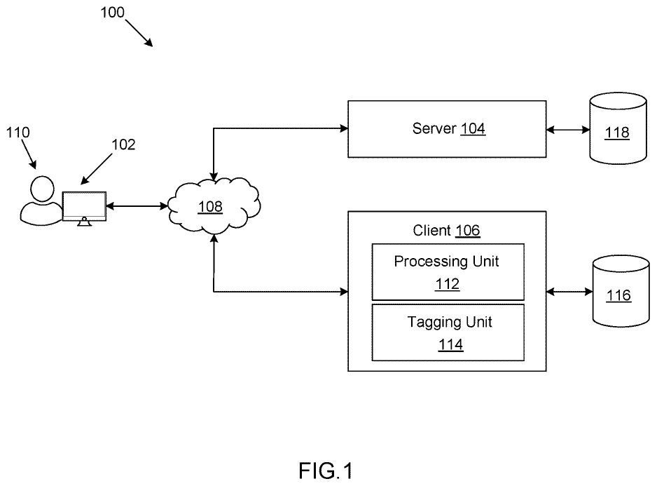

FIG. 1 illustrates a system 100 for analysing a plurality of failed test steps in test suites of a project, in accordance with an embodiment of the present disclosure. The system 100 includes a user device 102, a server 104, and a client 106. The user device 102, the server 104 and the client 106 communicate with each other over a communication network 108. The communication network 108 may be any suitable wired network, wireless network, a combination of these or any other conventional network, without limiting the scope of the present disclosure. Few examples may include a Local Area Network (LAN), wireless LAN connection, an Internet connection, a point-to-point connection, or other network connection and combinations thereof. In an example, the network may include a mobile communication network, for example, 2G, 3G, 4G, or 5G mobile communication network. The communication network may be coupled to one or more other networks, thereby providing coupling between a greater number of devices. Such can be the case, for example, when networks are coupled together via the Internet.

The user device 102 is monitored by a user 110 and relates to hardware component such as a keyboard, mouse, etc which accepts data from the user 110 and also relates to a hardware component such as a display screen of a desktop, laptop, tablet, etc. which displays data to the user 110. The user device 102 is configured to allow the user 110 to raise a request for analysing a plurality of test steps of a test suite or a test script (hereinafter interchangeably referred to as test suite or test script) and to display the result of the analysis of the plurality of test steps of the test suite to the user 110. The user 110 may be, but not limited to, an automation engineer analysing a software, any employ of an organisation trained to analyze a software, or a third party capable of analyzing a software.

The server 104 is configured to receive the request for analyzing the plurality of test steps of the test suite from the user device 110 and to send the received request for analyzing the plurality of test steps of the test suite to the client 106. The client 106 includes a processing unit 112, a tagging unit 114 and a client database 116. The processing unit 112 is configured to receive the request for analyzing the plurality of test steps of the test suite and to execute each of the plurality of test steps of the test suite to determine a result “Pass” if the test step of the test suite passes the execution without any error element and a result “Fail” if the test step of the test suite fails the execution due to an error element.

The processing unit 112 if further configured to send the plurality of test steps along with their generated result “Pass or Fail” to the server 104. The server 104 receives the plurality of test steps along with their generated result “Pass or Fail” and stores them in a server database 118. The server 104 also sends the plurality of test steps along with their generated result “Pass or Fail” to the user device 102 for displaying them to the user 110. In an embodiment of the present disclosure, the processing unit 112 may send the plurality of test steps along with their generated result “Pass or Fail” to the server 104 using Kafka. In another embodiment of the present disclosure, the processing unit 112 may send the plurality of test steps along with their generated result “Pass or Fail” to the server 104 using any technique known.

Further, the processing unit 112 is configured to extract a plurality of failed test steps from the plurality of test steps based on the generated result “Fail” and to send the extracted plurality of failed test steps to the tagging unit 114.

The tagging unit 114 is configured to receive the extracted plurality of failed test steps from the processing unit 112 and to analyze each of the extracted plurality of failed test steps to determine the error element of the plurality of failed test steps and if an error element identity is present in the plurality of failed test steps or not. The tagging unit 114 is further configured to create a tag for a failed test step from the plurality of failed test steps based on the error element and presence of determined error element identity.

When the error element identity is not present in the plurality of failed test steps in the test suite, the tagging unit 114 accepts a variable as an input from the user 110, compares the variable with browser window's title, and performs the following steps:
creates a project with project ID as “demoproject1”;
creates a module with script ID as “demoscript1”;
verifies if browser window's title matches the variable and maps it to a natural language processing name (NPL) ID as “demonlp1”;
maps error element with name as “Failed to verify browser window title”;
creates a tag for each of the plurality of failed test steps in a test suite with the project ID, license ID, test suite ID, script ID, NLP ID, and error element name.

When the error element identity is present in the plurality of failed test steps in the test suite, the tagging unit 114 performs the following steps:
creates a project with project ID “demotestauto1”;
creates a module with script ID as “demoscript1”;
verifies if “Failed to click “ELEMENT_1” link in home page”, and maps it to a NLP ID as “demonlp1”;
maps error element with name as “Element Not Found”;
maps “ELEMENT_1” to the Element ID as “demoelement1”;
creates a tag for each of the plurality of failed steps in a test suite with the project ID, license ID, test suite ID, script ID, NLP ID, and error element name.

When the error element identity is not present in the plurality of failed test steps in the test suites, the tagging unit 114 performs the following steps:
creates a project with project ID as “demotestauto1”;
creates a module with script Id as “demoscript1”;
verifies if browser window's title matches the variable and maps to a NPL ID as “demonlp1”;
maps error element with name as “Failed to verify browser window title”;
creates a tag for each of the plurality of failed steps in the test suites with the project ID, license ID, NLP ID, and error element name.

When the error element identity is present in the plurality of failed test steps in the test suites, the tagging unit 114 performs the following steps:
creates a project with project ID as “demotestauto1”;
creates a module with script ID as “demoscript1”;
verifies if “Failed to click “ELEMENT_1” link in home page”, and maps to a NLP ID as “demonlp1;
maps error element with name as “Element Not Found”;
maps “ELEMENT_1” to the Element ID as “demoelement1”;
creates a tag for each of the plurality of failed steps in a test suite with the project ID, license ID, NLP ID, and error element name.

Once the tag has been created, the tagging unit 114 requests for an input from the user 110 to select one of the options-apply tag only to the failed test step of the test suite for which it has been created, apply tag to all of the plurality of failed test steps of the test suite, or apply tag to all of the plurality of failed test steps of all the test suites, where the failed test step of the test suite, the plurality of failed test steps of the test suite, or the plurality of failed test steps the test suites have the same error element. The tagging unit 114 requests the input from the user 110 by displaying a selection screen on a display of the user device 102. The user 110 selects one or more options displayed on the user device 102 and the user device 102 sends the selected options to the tagging unit 114.

The tagging unit 114 receives the selected options and applies the created tag to the failed test step of the test suite, to the plurality of failed test steps of the test suite, or to the plurality of failed test steps the test suites based on the received selected options, where the failed test step of the test suite, the plurality of the failed test steps of the test suite or the test suites have the same error element.

After tagging the plurality of failed test steps in the test suite or in the test suites, the tagging unit 114 is configured to store the plurality of failed test steps along with their tags in the client database 116 and to send them to the user device 102 for displaying the failed test steps along with their tags to the user 110.

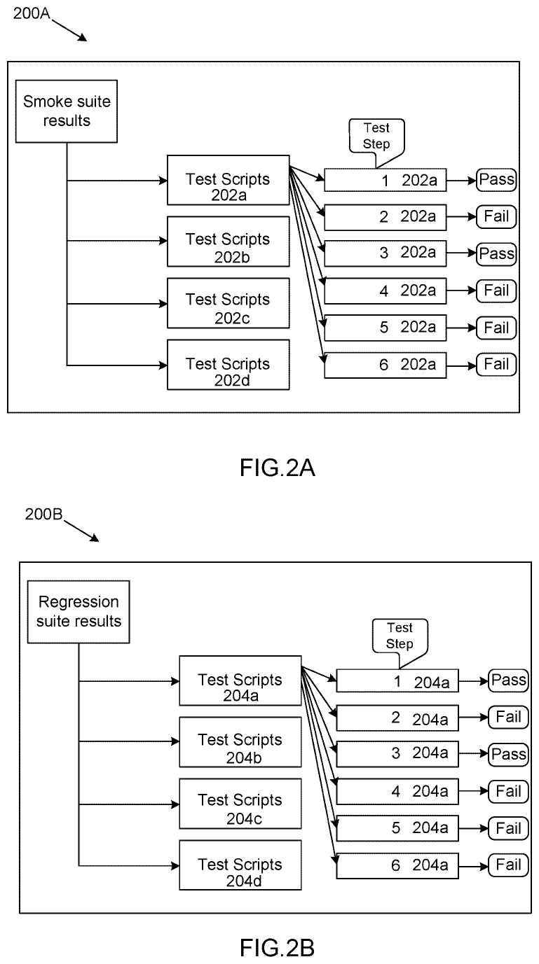

FIG. 2A and FIG. 2B illustrate an exemplary tagging of plurality of failed test steps in test suites, in accordance with an embodiment of the present disclosure. FIG. 2A illustrates a smoke test suite 200A which includes four test scripts 202a, 202b, 202c and 202d. The first test script 202a includes six test steps 202a-1, 202a-2, 202a-3, 202a-4, 202a-5, and 202a-6. Let us assume that the user 110 tries to click on an element (like a button) on a webpage which maybe present or may not be present in the test steps 202a-1 to 202a-6. The processing unit 112 receives the request from the server 104 and starts the execution. The processing unit 112 executes the first test script 202a by starting the execution at the first test step 202a-1. While executing the first test step 202a-1, the processing unit 112 determines that the element clicked by the user 110 is found in the first test 202a-1 and generates a result “Pass” for the first test 202a-1. Similarly, when the processing unit 112 executes the second test step 202a-2, the processing unit 112 determines that the element clicked by the user 110 is not found in the second test step 202a-2 and generates a result “Fail” for the second test step 202a-2. The processing unit 112 continues the same execution process for the test steps 202a-3 to 202a-6 and generates a result “Pass” for the test step 202a-3 and “Fail” for the test steps 202a-4 to 202a-6.

Similarly, FIG. 2B illustrates a regression test suite 200B which includes four test scripts 204a, 204b, 204c and 204d. The first test script 204a includes six test steps 204a-1, 204a-2, 204a-3, 204a-4, 204a-5, and 204a-6. Let us assume that the user 110 tries to click on an element (like a button) on a webpage which maybe present or may not be present in the test steps 204a-1 to 204a-6. The processing unit 112 receives the request from the server 104 and starts the execution. The processing unit 112 executes the first test script 204a by starting the execution at the first test step 204a-1. While executing the first test step 204a-1, the processing unit 112 determines that the element clicked by the user 110 is found in the first test 204a-1 and generates a result “Pass” for the first test 204a-1. Similarly, when the processing unit 112 executes the second test step 204a-2, the processing unit 112 determines that the element clicked by the user 110 is not found in the second test step 204a-2 and generates a result “Fail” for the second test step 204a-2. The processing unit 112 continues the same execution process for the test steps 204a-3 to 204a-6 and generates a result “Pass” for the test step 204a-3 and “Fail” for the test steps 204a-4 to 204a-6.

The processing unit 112 then sends the test steps (202a-1 to 202a-6) along with their generated results “Pass/Fail” to the server 104 which stores the result in the server database 118. The server 104 also sends the test steps (202a-1 to 202a-6) along with their generated results “Pass/Fail” to the user device 102 to display each of the test steps with their results “Pass or Fail” to the user 110.

Further, the processing unit 112 extracts the failed test steps (202a-2 and 202a-4 to 202a-6) from the test steps (202a-1 to 202a-6) of the test script 202a. The processing unit 112 then sends the failed test steps 202a-2 and 202a-4 to 202a-6 to the tagging unit 114. The tagging unit 114 receives the failed test steps 202a-2 and 202a-4 to 202a-6 and analyses each of the failed test steps 202a-2 and 202a-4 to 202a-6 to determine an error element in each of the failed test steps 202a-2 and 202a-4 to 202a-6 and if error element identity is present in the failed test steps 202a-2 and 202a-4 to 202a-6. The tagging unit 114 then creates a tag for a failed test step from the plurality of failed test steps in the test suite based on the error element and the presence of determined error element identity. After creating the tag, the tagging unit 114 requests an input from the user 110 to apply a tag to that particular failed test step of a test script or all the failed test steps having same error of that test script or all the failed test steps having same error of all the test scripts. For example, let us consider that the tagging unit 114 creates a tag for the test step 202a-2. Since the failed test steps 202a-2 and 202a-4 to 202a-6; and 204a-2 and 204a-4 to 204a-6 have the same error, the tagging unit 114 may request the user 110 whether to apply a tag to only failed test step 202a-2 of the test script 202a, or to all the failed test steps 202a-2, and 202a-4 to 202a-6 of the test script 202a, or to all the failed test steps 202a-2 and 202a-4 to 202a-6; and 204a-2 and 204a-4 to 204a-6 of the test scripts 202a and 204a.

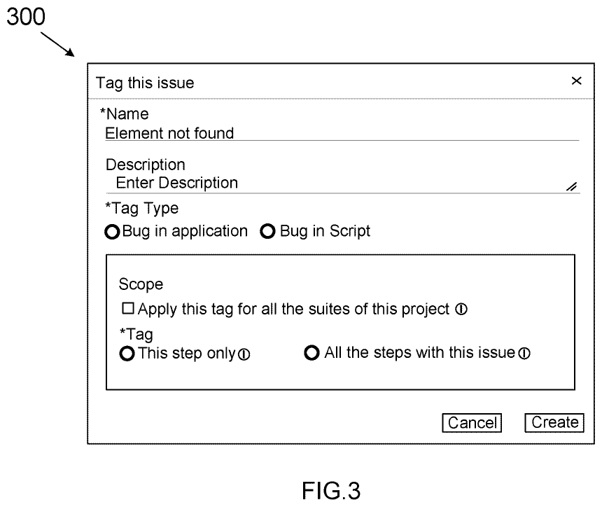

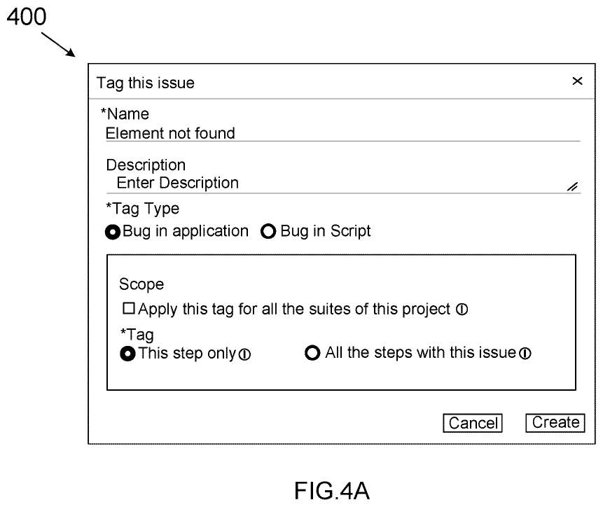

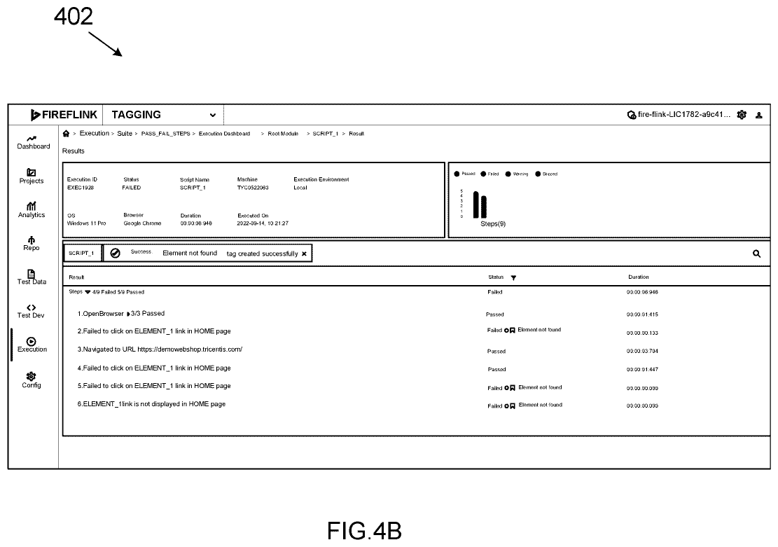

FIG. 3 illustrates an exemplary display screen 300 displayed on the user device 102 requesting an input from the user 110 for applying a tag to a failed test step, in accordance with an embodiment of the present disclosure. FIG. 3 illustrates that a tag under the heading “Name: Element not found” has been created by the tagging unit 114 and displayed to the user 110. The user 110 may put a description for a tag under the heading “Description”. The user 110 may also select a type of tag under the heading “Tag Type” by either selecting “Bug in Application” or “Bug in script”. Further, the user 110 may select “Apply this tag for all the suites of this project” under the heading “Scope”. This helps in applying a tag (for example “element not found”) to all the failed test steps having same error element (element not found) in all the test suites of a project. For example, as illustrated in FIGS. 2A and 2B, if the user 110 selects “Apply this tag for all the suites of this project”, the tagging unit 114 will tag all the failed test steps 202a-2, 202a-4 to 202a-6 and 204a-2 and 204a-4 to 204a-6 of the test scripts 202a and 204a. The user 110 may also select either “This step only” or “All the steps with this issue” under the heading “Tag”. On receiving a selection “This step only”, the tagging unit 114 tags only a failed test step of a test suite for which the tag has been created. For example, as illustrated in FIG. 2A, if the user 110 selects “This step only”, the tagging unit 114 will only tag the failed step 202a-2. On receiving a selection “All the steps with this issue”, the tagging unit 114 will tag all the failed steps 202a-2, 202a-4 to 202a-6 of the test script 202a. FIG. 4A illustrates an exemplary display screen 400 displayed on the user device 102 with a tag option selected by the user 110, in accordance with an embodiment of the present disclosure. FIG. 4A illustrates that the user 110 selects the tag type as “Bug in Application”. Further, the user 110 selects “This step only” under the heading “Tag” and selects the option “Create”. The tagging unit 114 receives the selection from the user device 102 and applies the named tag to the failed test step of a test suite for which the tag has been created (for example, the failed test step 202a-2 as illustrated in FIG. 2A). FIG. 4B illustrates a display screen 402 displayed on the user device 102 after a tag has been applied to a failed test step based on an input from the user 110, in accordance with an embodiment of the present disclosure. FIG. 4B illustrates displaying to the user 110 that “Element not found” tag has been generated successfully. FIG. 4B illustrates that the tag is generated only for the failed test step for which the tag was created (for example, the failed test step 202a-2 of the test suite 202a). FIG. 4B illustrates that the tagged failed test step is displayed with the name of the tag.

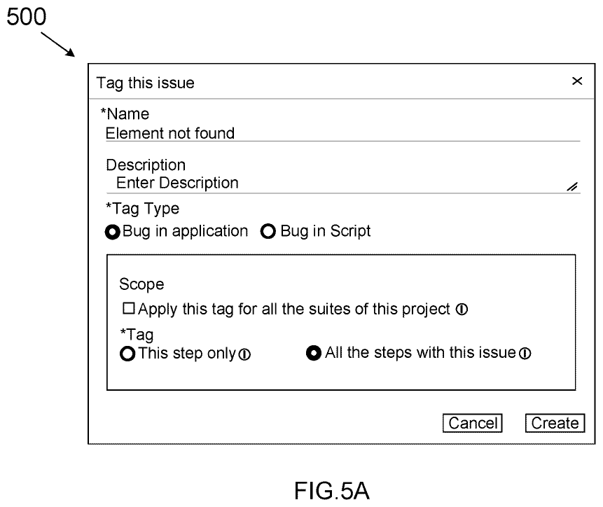

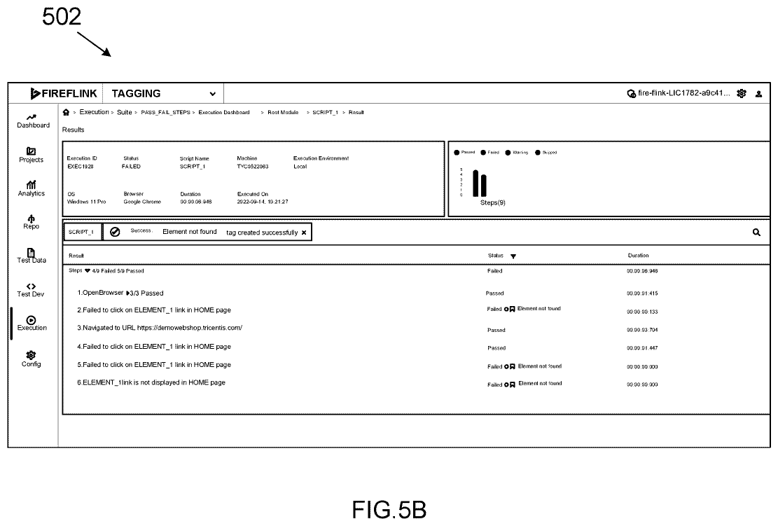

FIG. 5A illustrates an exemplary display screen 500 displayed on the user device 102 with a tag option selected by the user 110, in accordance with another embodiment of the present disclosure. FIG. 5A illustrates that the user 110 selects the tag type as “Bug in Application”. Further, the user 110 selects “All the steps with this issue” under the heading “Tag” and selects the option “Create”. The tagging unit 114 receives the selection from the user device 102 and applies the named tag to all the failed test steps of a test suite (for example, the failed test steps 202a-2 and 202a-4 to 202a-6 of the test suite 202a as illustrated in FIG. 2A). FIG. 5B illustrates an exemplary display screen 502 displayed on the user device 102 after a tag has been applied to all the failed test steps of a test suite based on an input from the user 110, in accordance with another embodiment of the present disclosure. FIG. 5B illustrates displaying to the user 110 that “Element not found” tag has been generated successfully. FIG. 5B illustrates that the tag is generated only for all the failed test steps of a test suite (for example, the failed test steps 202a-2 and 202a-4 to 202a-6 of the test suite 202a). FIG. 5B illustrates that the tagged failed test steps are displayed along with the name of the tag.

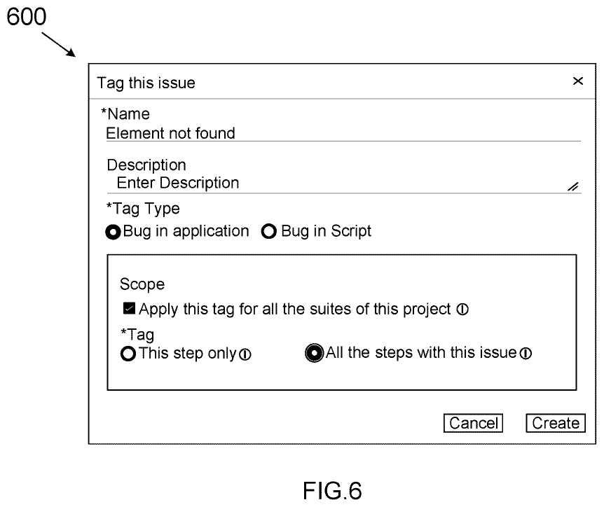

FIG. 6 illustrates an exemplary display screen 600 displayed on the user device 102 with a tag option selected by the user 110, in accordance with yet another embodiment of the present disclosure. FIG. 6 illustrates that the user 110 selects the tag type as “Bug in Application”. Further, the user 110 selects “Apply this tag for all the suites of this project” under the heading “Scope”. Also, the user 110 selects “All the steps with this issue” under the heading “Tag” and selects the option “Create”. The tagging unit 114 receives the selection from the user device 102 and applies the named tag to all the failed test steps of all the test suites of a project (for example, the failed test steps 202a-2 and 202a-4 to 202a-6 of the test suite 202a, and the failed test steps 204a-2 and 204a-4 to 204a-6 of the test suite 204a, as illustrated in FIG. 2A and FIG. 2B).

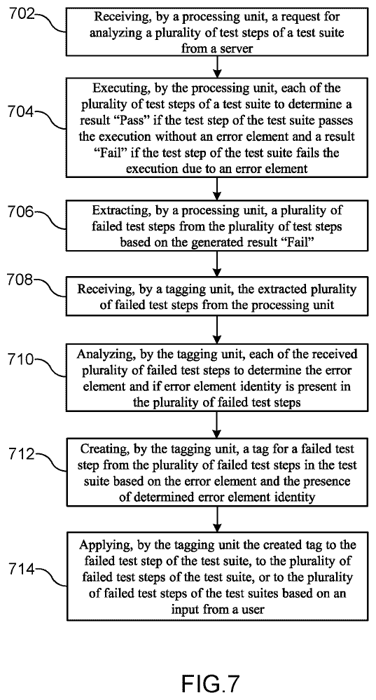

FIG. 7 illustrates a method 700 for analysing a plurality of failed test steps in test suites of a project, in accordance with an embodiment of the present disclosure. At step 702, the method includes receiving, by a processing unit 112, a request for analyzing a plurality of test steps of a test suite from a server 104. At step 704, the method includes executing, by the processing unit 112, each of the plurality of test steps of a test suite to determine a result “Pass” if the test step of the test suite passes the execution without an error and a result “Fail” if the test step of the test suite fails the execution due to an error.

At step 706, the method includes extracting, by a processing unit 112, a plurality of failed test steps from the plurality of test steps based on the generated result “Fail”. At step 708, the method includes receiving, by a tagging unit 114, the extracted plurality of failed test steps from the processing unit 112.

At step 710, the method includes analyzing, by the tagging unit 114, each of the received plurality of failed test steps to determine an error element and if error element identity is present in the plurality of failed test steps. At step 712, the method creating, by the tagging unit 114, a tag for a failed test step from the plurality of failed test steps in the test suite based on the error element and the presence of determined error element identity. At step 714, the method includes applying, by the tagging unit 114, the created tag to the failed test step of the test suite, to the plurality of failed test steps of the test suite, or to the plurality of failed test steps of the test suites based on an input from the user 110.

The system and method for analyzing a plurality of failed test steps in a test suite of a project have numerous advantages. Applying a tag to a failed test step with an error in a test suite, to all the failed test steps with same error in the same test suite, and to all the failed test steps with the same error across all the test suites of a projects helps in reducing execution iterations as well as avoiding redundancy in analysing failed test steps with same error. Further, automatically applying a tag to a failed test step with an error in a test suite, to all the failed test steps with same error in the same test suite, and to all the failed test steps with the same error across all the test suites of a projects relieves much of the manual requirements of the testing lifecycle.

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. A system (100) for analyzing a plurality of failed test steps in test suites of a project, the system (100) comprising:
a client (106) configured to receive a request for analyzing a plurality of test steps of a test suite from a server (104), wherein the client (106) comprises:
a processing unit (112) configured to:
execute each of the plurality of test steps of a test suite to determine a result “Pass” if the test step of the test suite passes the execution without an error element and a result “Fail” if the test step of the test suite fails the execution due to an error element; and
extract a plurality of failed test steps from the plurality of test steps based on the generated result “Fail”; and
a tagging unit (114) configured to:
receive the extracted plurality of failed test steps from the processing unit (112);
analyze each of the received plurality of failed test steps to determine the error element and if error element identity is present in the plurality of failed test steps;
create a tag for a failed test step from the plurality of failed test steps in the test suite based on the error element and the presence of determined error element identity; and
apply the created tag to the failed test step of the test suite, to the plurality of failed test steps of the test suite, or to the plurality of failed test steps of the test suites based on an input from the user (110).

2. The system (100) as claimed in claim 1, wherein the processing unit (112) sends the plurality of test steps along with their generated result “Pass or Fail” to the server (104), wherein the server (104) stores the plurality of test steps along with their generated result “Pass or Fail” in a server database (118).

3. The system as claimed in claim 2, wherein the server (104) sends the plurality of test steps along with their generated result “Pass or Fail” to the user device (102) for displaying them to the user (110).

4. The system (100) as claimed in claim 2, wherein the processing unit (112) sends the plurality of test steps along with their generated result “Pass or Fail” to the server (104) using Kafka.

5. The system (100) as claimed in claim 1, wherein if the error element identity is not present in the failed test step, the tagging unit (114) is configured to:
accept a variable as an input from a user (110),
create a project with project ID as “demoproject1”,
verify if a browser window's title matches the variable and map it to a natural language processing name (NPL) ID as “demonlp1”,
map error element with name as “Failed to verify browser window title”, and
create a tag for the failed test step with the project ID, license ID, test suite ID, script ID, NLP ID, and error element name.

6. The system (100) as claimed in claim 1, wherein if the error element identity is present in the failed test step, the tagging unit (114) is configured to:
create a project with project ID “demotestauto1”,
create a module with script ID as “demoscript1”,
verify if “Failed to click “ELEMENT_1” link in home page”, and map it to a NLP ID as “demonlp1,
map error element with name as “Element Not Found”,
map “ELEMENT_1” to the error Element ID as “demoelement1”, and
create a tag for the failed test step with the project ID, license ID, test suite ID, script ID, NLP ID, and error element name.

7. The system (100) as claimed in claim 1, wherein if the error element identity is not present in the plurality of failed test steps in the test suites, the tagging unit (114) is configured to:
accept a variable as an input from a user (110),
create a project with project ID as “demoproject1”,
verify if a browser window's title matches the variable and map it to a natural language processing name (NPL) ID as “demonlp1”,
map error element with name as “Failed to verify browser window title”, and
create a tag for the failed test steps in the test suites with the project ID, license ID, NLP ID, and error element name.

8. The system (100) as claimed in claim 1, wherein if the error element identity is present in the plurality of failed test steps in the test suites, the tagging unit (114) is configured to:
create a project with project ID “demotestauto1”,
create a module with script ID as “demoscript1”,
verify if “Failed to click “ELEMENT_1” link in home page”, and map it to a NLP ID as “demonlp1,
map error element with name as “Element Not Found”,
map “ELEMENT_1” to the error Element ID as “demoelement1”, and
create a tag for the failed test step with the project ID, license ID, NLP ID, and error element name.

9. The system (100) as claimed in claim 1, wherein the input from the user (110) comprises selecting one of the options—apply a tag only to the failed test step of the test suite for which the tag has been created, apply tag to all of the plurality of failed test steps of the test suite, or apply tag to all of the plurality of failed test steps of the test suites, wherein the failed test step of the test suite, the plurality of failed test steps of the test suite, or the plurality of failed test steps of the test suites have the same error element.

10. The system (100) as claimed in claim 1, wherein the tagging unit (114) is configured to store the plurality of failed test steps along with their tags in a client database (116), and to send the plurality of failed test steps along with their tags to the user device (102) for displaying the failed test steps along with their tags to the user (110).

11. A method (700) for analyzing a plurality of failed test steps in test suites of a project, the method (700) comprising:
receiving, by a processing unit (112), a request for analyzing a plurality of test steps of a test suite from a server (104);
executing, by the processing unit (112), each of the plurality of test steps of a test suite to determine a result “Pass” if the test step of the test suite passes the execution without an error element and a result “Fail” if the test step of the test suite fails the execution due to an error element;
extracting, by a processing unit (112), a plurality of failed test steps from the plurality of test steps based on the generated result “Fail”;
receiving, by a tagging unit (114), the extracted plurality of failed test steps from the processing unit (112);
analyzing, by the tagging unit (114), each of the received plurality of failed test steps to determine the error element and if error element identity is present in the plurality of failed test steps;
creating, by the tagging unit (114), a tag for a failed test step from the plurality of failed test steps in the test suite based on the error element and the presence of determined error element identity; and
applying, by the tagging unit (114), the created tag to the failed test step of the test suite, to the plurality of failed test steps of the test suite, or to the plurality of failed test steps of the test suites based on an input from the user (110).

12. The method (700) as claimed in claim 11, wherein the method comprises sending, by the processing unit (112), the plurality of test steps along with their generated result “Pass or Fail” to the server (104) and storing the plurality of test steps along with their generated result “Pass or Fail” in a server database (118) by the server (104).

13. The method (700) as claimed in claim 12, wherein the method comprises sending, by the server (104), the plurality of test steps along with their generated result “Pass or Fail” to the user device (102) for displaying them to the user (110).

14. The method (700) as claimed in claim 11, wherein if the error element identity is not present in the failed test step, the tagging unit (114) is configured to:
accept a variable as an input from a user (110),
create a project with project ID as “demoproject1”,
verify if a browser window's title matches the variable and map it to a natural language processing name (NPL) ID as “demonlp1”,
map error element with name as “Failed to verify browser window title”, and
create a tag for the failed test step with the project ID, license ID, test suite ID, script ID, NLP ID, and error element name.

15. The method (700) as claimed in claim 11, wherein if the error element identity is present in the failed test step, the tagging unit (114) is configured to:
create a project with project ID “demotestauto1”,
create a module with script ID as “demoscript1”,
verify if “Failed to click “ELEMENT_1” link in home page”, and map it to a NLP ID as “demonlp1,
map error element with name as “Element Not Found”,
map “ELEMENT_1” to the error Element ID as “demoelement1”, and
create a tag for the failed test step with the project ID, license ID, test suite ID, script ID, NLP ID, and error element name.

16. The method (700) as claimed in claim 11, wherein if the error element identity is not present in the plurality of failed test steps in the test suites, the tagging unit (114) is configured to:
accept a variable as an input from a user (110),
create a project with project ID as “demoproject1”,
verify if a browser window's title matches the variable and map it to a natural language processing name (NPL) ID as “demonlp1”,
map error element with name as “Failed to verify browser window title”, and
create a tag for the failed test steps in the test suites with the project ID, license ID, NLP ID, and error element name.

17. The method (700) as claimed in claim 11, wherein if the error element identity is present in the plurality of failed test steps in the test suites, the tagging unit (114) is configured to:
create a project with project ID “demotestauto1”,
create a module with script ID as “demoscript1”,
verify if “Failed to click “ELEMENT_1” link in home page”, and map it to a NLP ID as “demonlp1,
map error element with name as “Element Not Found”,
map “ELEMENT_1” to the error Element ID as “demoelement1”, and
create a tag for the failed test step with the project ID, license ID, NLP ID, and error element name.

18. The method (700) as claimed in claim 11, wherein the input from the user (110) comprises selecting one of the options—apply a tag only to the failed test step of the test suite for which the tag has been created, apply tag to all of the plurality of failed test steps of the test suite, or apply tag to all of the plurality of failed test steps of the test suites, wherein the failed test step of the test suite, the plurality of failed test steps of the test suite, or the plurality of failed test steps of the test suites have the same error element.

19. The method (700) as claimed in claim 11, wherein the method comprises storing, by the tagging unit (114), the plurality of failed test steps along with their tags in a client database (116), and sending, by the tagging unit (114), the plurality of failed test steps along with their tags to the user device (102) for displaying the failed test steps along with their tags to the user (110).
